(19) United States
(12) Patent Application Publication
(10) Pub. No.: US 2020/0361240 A1
(43) Pub. Date: Nov. 19, 2020

(54) ARTICULATED SHAFT

(71) Applicant: AKTIEBOLAGET SKF, Goteborg (SE)

(72) Inventor: Bernd Stephan, Schweinfurt (DE)

(21) Appl. No.: 16/865,835

(22) Filed: May 4, 2020

(30) Foreign Application Priority Data
May 16, 2019 (DE) 102019207145.7

(51) Int. Cl. B60B 35/12; B60B 35/18

(52) U.S. Cl. CPC B60B 35/128; B60B 35/18; B60B 2360/3416; B60B 2360/102; B60B 2360/108; B60B 2310/202

(57) ABSTRACT

An articulated shaft includes a hollow shaft and a joint formed by a first outer ring element and a first inner ring element in the interior of the first outer ring element which joint is configured to transmit a torque from the hollow shaft to an axle connected to the inner ring element. The outer ring element is formed one-piece with the hollow shaft and/or the inner ring element is formed one-piece with the axle.

### CROSS-REFERENCE

This application claims priority to German patent application no. 10 2019 207 145.7 filed on May 16, 2019, the contents of which are fully incorporated herein by reference.

### TECHNOLOGICAL FIELD

The present disclosure is directed to an articulated shaft and to a hollow shaft for use in an articulated shaft and to an axle for use in an articulated shaft.

### BACKGROUND

Articulated shafts that are comprised of a hollow shaft, and one or two joints that are disposed at one or both ends of the hollow shaft, are used to transmit a torque from the hollow shaft to an axle connected to the articulated shaft. For this purpose the joint includes an outer ring element and an inner ring element that is arrangeable in the interior of the outer ring element. Such articulated shafts can be used as drive shafts in trucks or as a shaft between a wheel hub and a differential, for example, in electric vehicles.

In articulated shafts used up to now, the outer ring element is attached to the hollow shaft as a separate element, for example, by welding. However, this requires a separate manufacturing step in order to connect the outer ring element to the hollow shaft. Furthermore, both the outer ring element and the hollow shaft must provide sufficient material to permit such a weld connection, which increases the weight of the articulated shaft. In addition, during transmission of the torque a torsional force is exerted on the connection between the hollow shaft and the outer ring element. The higher the torque is, the higher this torsional force becomes, and it can damage the connection between the hollow shaft and the outer ring element. This connection thus represents a weak point of the articulated shaft.

### SUMMARY

It is therefore an aspect of the present disclosure to provide an articulated shaft that can be manufactured simply and with low weight.

The articulated shaft includes a hollow shaft and a joint, wherein the joint includes an outer ring element and an inner ring element that is arrangeable in the interior of the outer ring element. Here the joint is configured to transmit a torque from the hollow shaft to an axle connected to the inner ring element.

In order to allow for a simple manufacturing and a weight reduction of the articulated shaft, the outer ring element is formed one-piece with the hollow shaft. Alternatively or additionally the inner ring element can be configured one-piece with the axle connected to it. Due to this single-piece design it is possible to reduce the weight in comparison to previous articulated shafts.

Furthermore, the manufacturing method can be simplified by the single-piece design, since no additional manufacturing step is required for connecting the outer ring element and the hollow shaft, or the inner ring element and the axle connected thereto. Furthermore, no further manufacturing steps are required, such as, for example, manufacturing a flange for connecting the outer ring element to the hollow shaft, or the inner ring element to the axle. This also reduces the weight and the manufacturing costs.

The articulated shaft disclosed here can be implemented with a variety of joints. The joint can be equipped with a plain bearing or a rolling-element bearing. For example, the articulated shaft can be used as a drive shaft in a truck, for example, including a tripod joint. Such a tripod joint is explained, for example, in DE 10 2008 026 063 A1. Here it is advantageous in particular to use a hollow shaft having the largest possible diameter in the length required for a drive shaft, and to flange the outer ring element on both sides.

Alternatively the articulated shaft can be used on a wheel hub in a motor vehicle, in particular an electric vehicle, to connect the wheel hub to the differential. If the articulated shaft is connected to a wheel hub, it is advantageous to configure the articulated shaft such that all shaft diameters, i.e., also the outer ring element formed one-piece with the hollow shaft, are smaller than the diameter of the outer ring of the wheel-hub bearing unit. In this way it can be ensured that the articulated shaft can be installed in the motor vehicle through the hole of the axle joint.

If the articulated shaft includes a tripod joint, the tripod joint can include, for example, three needle roller bearings. In general an axial length compensation can be effected by a tripod joint.

An inner ring of the tripod joint, in particular including three needle roller bearings, can be connected on one side to the drive shaft, and on the other side to the pinion shaft of the differential transmission housing.

However, due to the various possibilities of the joints, the articulated shaft disclosed here can be used generally in the broadest fields. For example, the articulated shaft can be used as a control and drive shaft in all land vehicles, watercraft, and aircraft. Among other things, it can be used in helicopters or airplanes for rotor control or in control surfaces, for example, rudders. The articulated shaft can also be used for all vehicle types such as trucks or electric vehicles, as well as trains or ships.

According to a further embodiment, the outer ring element forms a raceway of an outer ring, or the outer ring element forms an outer ring carrier that radially supports an outer ring forming the raceway, wherein the outer ring element at least partially receives the cylindrical outer surface of the outer ring. In each case the outer ring element is formed one-piece with the hollow shaft and can either directly form a raceway of the outer ring, or form a carrier into which an outer ring can be inserted, for example. If the articulated shaft is viewed from outside, in each case only a one-piece element, i.e., the hollow shaft including the outer ring element, can be seen.

According to a further embodiment, a wall thickness of the hollow shaft is reinforced in the region of the outer ring element. Due to this reinforcing the function of the joint can be ensured and the weight of the hollow shaft can simultaneously be reduced. This reinforcing can be achieved by processing the material of the hollow shaft. For example, the hollow shaft can be processed in the region of the outer ring by compressing, crimping, folding, or similar manufacturing methods that thicken the material of the hollow shaft in the region of the outer ring element.

According to a further embodiment, the outer ring element or the inner ring element can include a reinforcing element in order to make this reinforcing possible. The reinforcing element can be configured to reinforce the wall thickness of the hollow shaft. For example, the reinforcing element can be configured as a reinforcing ring that can be pushed into the hollow shaft or pushed onto the hollow shaft and be held there by friction-fit or press-fit. Alternatively the reinforcing element can also be directly incorporated into the material of the hollow shaft during manufacturing of the hollow shaft, for example, by casting, impressing, or wrapping.

According to a further embodiment, the reinforcing element can form a raceway of the outer ring.

The outer ring element or the inner ring element can be formed by reshaping (cold or hot forming), casting, pressing, wrapping, or laying. For example, the hollow shaft can be reshaped at its one or both ends by these machine formings such that the outer ring element is formed as is described above. This also applies for the axle and for forming the inner ring element. Alternatively the outer ring element and/or the inner ring element can be formed by pressing onto the hollow shaft and/or the axle.

The hollow shaft, the outer ring element, and/or the inner ring element, or the axle, can be manufactured from various materials. These include, for example, metal, in particular high-strength steel or titanium or steel alloys, plastic, in particular fiber-reinforced plastic, or carbon, in particular fiber-reinforced carbon. Due to these materials a sufficient stability and strength of the hollow shaft, and thus of the outer ring element, and/or the axle, and thus of the inner ring element, can be insured, while the weight can simultaneously be reduced.

In the region of the joint a seal element can be provided in the hollow shaft in order to allow a sealing of the joint toward the interior of the hollow shaft. Furthermore, such a seal element can also be disposed such that the joint is sealed off with respect to the external environment.

According to a further embodiment, the diameter and the wall thickness of the hollow shaft, and of the outer ring element formed one-piece with the hollow shaft, are optimized with respect to the weight and the torque to be transmitted. This means that during manufacturing, the diameter and the wall thickness are chosen such that a torque to be transmitted can be maximized and the weight can be minimized. Depending on the application purpose, the torque to be transmitted is determined here, and the weight and thus the diameter and the wall thickness are adapted accordingly.

According to a further aspect, a hollow shaft is disclosed including an outer ring element, as is described above, formed one-piece therewith. Such a hollow shaft can be used in the above-described articulated shaft.

According to a further aspect, an axle is disclosed including an inner ring element, as is described above, formed one-piece therewith. Such an axle can be used in the above-described articulated shaft.

According to a further aspect, a wheel hub module is disclosed, wherein the wheel hub module includes a wheel hub bearing unit, as well as an articulated shaft as is described above. Here the wheel hub bearing unit is connected to the articulated shaft.

According to a further aspect, a drive shaft of a truck is disclosed, wherein the drive shaft is configured as an articulated shaft as is described above.

According to a further aspect, an installation method is disclosed for installing an articulated shaft as is described above. Here the articulated shaft serves for connecting a hollow shaft as described above and an axle as described above, wherein the articulated shaft is installable in the above-described wheel hub module or as a drive shaft as is described above.

Further advantages and advantageous embodiments are specified in the description, the drawings, and the claims. Here in particular the combinations of features specified in the description and in the drawings are purely exemplary, so that the features can also be present individually or combined in other ways.

In the following the invention shall be described in more detail using exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 shows an articulated shaft including a hollow shaft and two joints.

FIG. 2 shows an inner ring of the articulated shaft of FIG. 1.

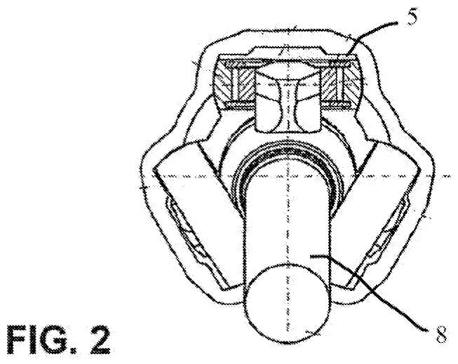

### DETAILED DESCRIPTION

In the following, identical or functionally equivalent elements are designated by the same reference numbers.

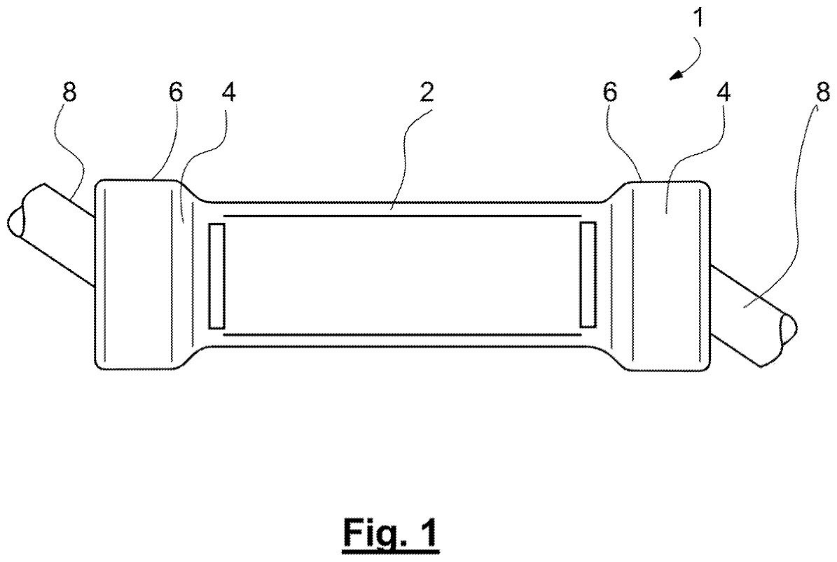

FIG. 1 shows an articulated shaft 1. The articulated shaft 1 includes a hollow shaft 2 and a joint 4. In the embodiment shown here, such a joint 4 is disposed on both ends of the hollow shaft 2. Alternatively, a joint 4 can be disposed on one of the two ends of the hollow shaft 2.

The joint 4 includes an outer ring element 6 and an inner ring element 5 that is arrangeable in the interior of the outer ring element 6. The joint 4 is configured to transmit a torque from the hollow shaft 2 to an axle 8 connected to the inner ring element 5. In order to optimize the articulated shaft 1 with respect to weight, the outer ring element 6 is configured one-piece with the hollow shaft 2. Alternatively or additionally the inner ring element 5 can be configured one-piece with the axle 8 connected to it.

The joint 4 can be, for example, a tripod joint or a constant velocity joint. The outer ring element 6 can directly form a raceway of an outer ring, or form an outer ring carrier that radially supports an outer ring forming the raceway. Viewed from radially from the outside, in each case the outer ring element 6 and the hollow shaft 2 is configured as a one-piece element.

In order to ensure a proper functioning of the joint 4, the hollow shaft can be reinforced in the region of the outer ring element 6. This reinforcement can be effected by a corresponding processing of the material of the hollow shaft 2. For example, the material of the hollow shaft 2 can be compressed, crimped, or folded. Alternatively the reinforcing can be effected by a separate reinforcing element. The reinforcing element can be pushed into the hollow shaft 2 as a reinforcing ring or pushed-on onto the hollow shaft 2.

The diameter and the wall thickness of the hollow shaft 2, and of the outer ring element 6 formed one-piece with the hollow shaft 2, can be optimized with respect to the weight in a manner depending on the torque to be transmitted. Depending on the application, the diameter and the wall thickness can therefore be adapted to achieve the optimal weight for a certain torque to be transmitted. In this way the weight can be minimized and the torque to be transmitted can be maximized.

The articulated shaft 1 described here can be used as a drive shaft in a truck, for example, including a tripod joint. Alternatively the articulated shaft 1 can be used on a wheel hub in a motor vehicle, in particular an electric vehicle, to connect the wheel hub to the differential. If the articulated shaft 1 is connected to a wheel hub, the articulated shaft 1 is to be adapted such that all shaft diameters, i.e., also the outer ring element 6 formed one-piece with the hollow shaft 2, are smaller than the diameter of the outer ring of the wheel hub bearing unit. In this way it can be ensured that the articulated shaft 1 can be installed in the motor vehicle through the hole of the axle joint.

Due to the articulated shaft disclosed here it is possible to provide an articulated shaft for various application purposes, wherein manufacturing can be simplified and the manufacturing costs and the weight of the articulated shaft can be reduced.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved articulated shafts.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Articulated shaft
2 Hollow shaft
4 Joint
6 Outer ring element
8 Axle

What is claimed is:

1. An articulated shaft comprising:
a hollow shaft; and
a joint comprising a first outer ring element and a first inner ring element in an interior of the first outer ring element,
wherein the joint is configured to transmit a torque from the hollow shaft to an axle connected to the inner ring element, and
wherein the outer ring element is formed one-piece with the hollow shaft and/or the inner ring element is formed one-piece with the axle.

2. The articulated shaft according to claim 1, wherein the joint is a tripod joint or a constant velocity joint.

3. The articulated shaft according to claim 1, wherein the outer ring element forms a raceway of an outer ring, or wherein the outer ring element forms an outer ring carrier that radially supports an outer ring forming the raceway, wherein the outer ring element at least partially receives a cylindrical outer surface of the outer ring.

4. The articulated shaft according to claim 1, wherein a wall thickness of the hollow shaft is reinforced in the region of the outer ring element.

5. The articulated shaft according to claim 4, wherein the outer ring element or the inner ring element includes a reinforcing element that reinforces the wall thickness of the hollow shaft.

6. The articulated shaft according to claim 5, wherein the reinforcing element forms a raceway of an outer ring.

7. The articulated shaft according to claim 1, wherein the outer ring element or the inner ring element is formed by reshaping, in particular cold or hot forming, casting, pressing, wrapping, or laying.

8. The articulated shaft according to claim 1, wherein the hollow shaft, the outer ring element, and/or the inner ring element is manufactured from metal.

9. The articulated shaft according to claim 1, wherein the hollow shaft, the outer ring element, and/or the inner ring element is manufactured from steel or titanium or a steel alloy, or fiber-reinforced plastic or fiber-reinforced carbon.

10. The articulated shaft according to claim 1, wherein the diameter and the wall thickness of the hollow shaft and of the outer ring element formed one-piece with the hollow shaft is optimized with respect to the weight and the torque to be transmitted.

11. A hollow shaft including an outer ring element formed one-piece therewith and configured to receive an inner shaft to form the articulated shaft according to claim 1.

12. An axle including an inner ring element formed one-piece therewith configured to be received in the hollow shaft of claim 11.

13. A wheel hub module including a wheel hub bearing unit and an articulated shaft according to claim 1, wherein the wheel hub bearing unit is connected to the articulated shaft.

14. The articulated shaft according to claim 1, wherein the outer ring element is formed one-piece with the hollow shaft and the inner ring element is formed one-piece with the axle.

15. An articulated shaft comprising:
a unitary hollow shaft having an end portion configured as an outer ring element; and
an axle having an inner ring element at one end,
wherein the inner ring element is mounted in the outer ring element to form a joint configured to transmit a torque from the hollow shaft to the axle.

16. The articulated shaft according to claim 15, wherein the inner ring element is formed one-piece with the axle.

17. The articulated shaft according to claim 16, wherein the joint is a tripod joint or a constant velocity joint.

18. The articulated shaft according to claim 15, wherein the joint is a tripod joint or a constant velocity joint.

19. The articulated shaft according to claim 18, wherein a diameter of the end portion of the unitary hollow shaft is greater than a diameter of a central portion of the unitary hollow shaft.
